(19) United States
(12) Patent Application Publication
(10) Pub. No.: US 2003/0125978 A1
(43) Pub. Date: Jul. 3, 2003

(54) Method of obtaining infringement evidence and enforcing intellectual property

(76) Inventor: Robert John Paradiso, Scotch Plains, NJ (US)

Correspondence Address: Robert John Paradiso, 334 Miltonia St., Linden, NJ, 07036, US

(21) Appl. No.: 10/299,992

(22) Filed: Nov. 19, 2002

Related U.S. Application Data
(60) Provisional application No. 60/331,676, filed on Nov. 19, 2001.

(51) Int. Cl. G06F 17/60

(52) U.S. Cl. 705/1

(57) ABSTRACT

In certain embodiments, the invention is directed to a method of obtaining infringement evidence comprising broadcasting a description of intellectual property over a communications medium and offering an incentive to a party who submits evidence regarding infringement of the intellectual property. In preferred embodiments, the communications medium is a website and the intellectual property is a trademark. Also disclosed are methods of obtaining invalidation evidence.

This application claims priority from U.S. Provisional Application No. 60/331,676 filed Nov. 19, 2001, the disclosure of which is hereby incorporated by reference in its entirety for all purposes.

### BACKGROUND

Patents, trademarks and copyrights can be valuable assets to the individuals and corporations having rights in them. However, in order for intellectual properties to be most valuable, those having rights in these properties should take appropriate measures in order to assure that their patents, trademarks and/or copyrights are not being infringed.

For example, infringement of a patent can decrease market share of one having rights in a patent, and/or result in lost revenue as the infringer is not paying any royalty or licensing fees to practice the invention of the patent. Infringement of a trademark can dilute and devalue this property to the one who has rights in the trademark. Infringement of a copyright can deprive an artist profits from his or her own work.

The problem is that it is difficult and expensive to police the activity of the population in order to obtain evidence of infringement of one's intellectual property rights. An individual or corporation would need to have an extremely large team of workers in order to investigate and obtain infringement evidence.

There exists a need to provide those having rights in intellectual property a method to obtain infringement evidence regarding the same.

### OBJECTS AND SUMMARY OF THE INVENTION

It is an object of certain embodiments of the invention to provide a method for those having rights in intellectual property to obtain infringement evidence.

It is an object of certain embodiments of the invention to provide a method for those having rights in intellectual property to obtain infringement evidence which does not require an excessive number of employees.

It is an object of certain embodiments of the invention to provide a method for those having rights in intellectual property to obtain infringement evidence which is cost effective.

It is an object of certain embodiments of the invention to provide a method for those having rights in intellectual property to obtain invalidation evidence.

The above objects of the invention and others are achieved by virtue of the present invention which in certain embodiments is directed to a method of obtaining infringement evidence comprising broadcasting a description of intellectual property over a communications medium and offering an incentive to a party who submits evidence regarding infringement of the intellectual property.

Certain embodiments of the invention are directed to a method of obtaining infringement evidence comprising broadcasting a description of desired intellectual property infringement evidence over a communications medium and offering an incentive to a party who submits the evidence.

Certain embodiments of the invention are directed to a method of obtaining infringement evidence comprising providing a communications medium; broadcasting over the communications medium a description of intellectual property and an incentive offer to a party who submits evidence regarding infringement of the intellectual property.

Certain embodiments of the invention are directed to a method of obtaining infringement evidence comprising providing a communications medium; broadcasting over the communications medium a description of desired intellectual property infringement evidence and an incentive offer to a party who submits the evidence.

Certain embodiments of the invention are directed to a method of obtaining infringement evidence comprising hosting a communications medium; soliciting a user to broadcast over the communications medium a description of intellectual property and an incentive offer to a party who submits evidence regarding infringement of the intellectual property.

Certain embodiments of the invention are directed to a method of obtaining infringement evidence comprising hosting a communications medium; soliciting a user to broadcast over the communications medium a description of desired intellectual property infringement evidence and an incentive offer to a party who submits evidence regarding infringement of the intellectual property.

Certain embodiments of the invention are directed to a method of obtaining infringement evidence comprising hosting a communications medium; soliciting to broadcast on behalf of a user over the communications medium a description of intellectual property and an incentive offer to a party who submits evidence regarding infringement of the intellectual property.

Certain embodiments of the invention are directed to a method of obtaining infringement evidence comprising hosting a communications medium; soliciting to broadcast on behalf of a user over the communications medium a description of intellectual property infringement evidence and an incentive offer to a party who submits evidence regarding infringement of the intellectual property.

Certain embodiments of the invention are directed to a method of obtaining infringement evidence comprising hosting a communications medium; soliciting users to broadcast a description of intellectual property over the communications medium and offer an incentive to a party who submits evidence regarding infringement of the intellectual property and allowing the user to broadcast over the communications medium a description of intellectual property and an incentive offer to a party who submits evidence regarding infringement of the intellectual property.

Certain embodiments of the invention are directed to a method of obtaining infringement evidence comprising hosting a communications medium; soliciting users to broadcast a description of desired intellectual property infringement evidence over the communications medium and offer an incentive to a party who submits evidence regarding infringement of the intellectual property and allowing the user to broadcast over the communications medium a description of desired intellectual property infringement evidence and an incentive offer to a party who submits evidence regarding infringement of the intellectual property.

Certain embodiments of the invention are directed to a method of obtaining infringement evidence comprising hosting a communications medium; soliciting users who desire intellectual property infringement evidence and broadcasting on behalf of the user a description of intellectual property over the communications medium and offer an incentive to a party who submits evidence regarding infringement of the intellectual property.

Certain embodiments of the invention are directed to a method of obtaining infringement evidence comprising hosting a communications medium; soliciting users who desire intellectual property infringement evidence and broadcasting on behalf of the user over the communications medium a description of desired intellectual property infringement evidence and an incentive offer to a party who submits evidence regarding infringement of the intellectual property.

Certain embodiments of the invention are directed to a method of obtaining infringement evidence comprising contacting a host of a communications medium; broadcasting over the communications medium a description of intellectual property and an incentive offer to a party who submits evidence regarding infringement of the intellectual property.

Certain embodiments of the invention are directed to a method of obtaining infringement evidence comprising contacting a host of a communications medium; broadcasting over the communications medium a description of desired intellectual property infringement evidence and an incentive offer to a party who submits evidence regarding infringement of the intellectual property.

Certain embodiments of the invention are directed to a method of obtaining infringement evidence comprising contacting a host of a communications medium; having the host broadcast over the communications medium a description of intellectual property and an incentive offer to a party who submits evidence regarding infringement of the intellectual property.

Certain embodiments of the invention are directed to a method of obtaining infringement evidence comprising contacting a host of a communications medium; having the host broadcast over the communications medium a description of intellectual property infringement evidence and an incentive offer to a party who submits evidence regarding infringement of the intellectual property.

Certain embodiments of the invention are directed to a method of obtaining infringement evidence comprising broadcasting over a communications medium and offering an incentive to a party who submits evidence regarding infringement of an intellectual property.

Certain embodiments of the invention are directed to a method of obtaining infringement evidence comprising broadcasting over a communications medium and offering an incentive to a party who submits evidence regarding infringement of an intellectual property and organizing a database of intellectual property infringement evidence.

The above embodiments of the invention can also be used to obtain invalidation evidence of an intellectual property.

Certain embodiments of the invention are directed to a method of obtaining invalidation evidence comprising broadcasting a description of an intellectual property over a communications medium and offering an incentive to a party who submits evidence regarding invalidation of the intellectual property.

Certain embodiments of the invention are directed to a method of obtaining invalidation evidence comprising broadcasting a description of desired intellectual property invalidation evidence over a communications medium and offering an incentive to a party who submits evidence regarding invalidation of the intellectual property.

Certain embodiments of the invention are directed to a method of obtaining invalidation evidence comprising providing a communications medium; broadcasting over the communications medium a description of an intellectual property and an incentive offer to a party who submits evidence regarding invalidation of the intellectual property.

Certain embodiments of the invention are directed to a method of obtaining invalidation evidence comprising providing a communications medium; broadcasting over the communications medium a description of desired intellectual property invalidation evidence and an incentive offer to a party who submits evidence regarding invalidation of the intellectual property.

Certain embodiments of the invention are directed to a method of obtaining invalidation evidence comprising hosting a communications medium; soliciting a user to broadcast over the communications medium a description of an intellectual property and an incentive offer to a party who submits evidence regarding invalidation of the intellectual property.

Certain embodiments of the invention are directed to a method of obtaining invalidation evidence comprising hosting a communications medium; soliciting a user to broadcast over the communications medium a description of desired intellectual property invalidation evidence and an incentive offer to a party who submits evidence regarding invalidation of the intellectual property.

Certain embodiments of the invention are directed to a method of obtaining invalidation evidence comprising hosting a communications medium; soliciting to broadcast on behalf of a user over the communications medium a description of an intellectual property and an incentive offer to a party who submits evidence regarding invalidation of the intellectual property.

Certain embodiments of the invention are directed to a method of obtaining invalidation evidence comprising hosting a communications medium; soliciting to broadcast on behalf of a user over the communications medium a description of intellectual property invalidation evidence and an incentive offer to a party who submits evidence regarding invalidation of the intellectual property.

Certain embodiments of the invention are directed to a method of obtaining invalidation evidence comprising hosting a communications medium; soliciting users to broadcast a description of an intellectual property over the communications medium and offer an incentive to a party who submits evidence regarding invalidation of the intellectual property and allowing the user to broadcast over the communications medium a description of an intellectual property and an incentive offer to a party who submits evidence regarding invalidation of the intellectual property.

Certain embodiments of the invention are directed to a method of obtaining invalidation evidence comprising hosting a communications medium; soliciting users to broadcast a description of desired intellectual property invalidation evidence over the communications medium and an offer of an incentive to a party who submits evidence regarding invalidation of the intellectual property and allowing the user to broadcast over the communications medium a description of desired intellectual property invalidation evidence and an incentive offer to a party who submits evidence regarding invalidation of the intellectual property.

Certain embodiments of the invention are directed to a method of obtaining invalidation evidence comprising hosting a communications medium; soliciting users who desire intellectual property invalidation evidence and broadcasting on behalf of the user a description of an intellectual property over the communications medium and offer an incentive to a party who submits evidence regarding invalidation of the intellectual property.

Certain embodiments of the invention are directed to a method of obtaining invalidation evidence comprising hosting a communications medium; soliciting a user who desires intellectual property invalidation evidence and broadcasting on behalf of the user over the communications medium a description of desired intellectual property invalidation evidence and an incentive offer to a party who submits evidence regarding invalidation of the intellectual property.

Certain embodiments of the invention are directed to a method of obtaining invalidation evidence comprising contacting a host of a communications medium; broadcasting over the communications medium a description of an intellectual property and an incentive offer to a party who submits evidence regarding invalidation of the intellectual property.

Certain embodiments of the invention are directed to a method of obtaining invalidation evidence comprising contacting a host of a communications medium; broadcasting over the communications medium a description of desired intellectual property invalidation evidence and an incentive offer to a party who submits evidence regarding invalidation of the intellectual property.

Certain embodiments of the invention are directed to a method of obtaining invalidation evidence comprising contacting a host of a communications medium; having the host broadcasting over the communications medium a description of an intellectual property and an incentive offer to a party who submits evidence regarding invalidation of the intellectual property.

Certain embodiments of the invention are directed to a method of obtaining invalidation evidence comprising contacting a host of a communications medium; having the host broadcast over the communications medium a description of intellectual property invalidation evidence and an incentive offer to a party who submits evidence regarding invalidation of the intellectual property.

Certain embodiments of the invention are directed to a method of obtaining invalidation evidence comprising broadcasting over a communications medium and offering an incentive to a party who submits evidence regarding invalidation of an intellectual property.

Certain embodiments of the invention are directed to a method of obtaining invalidation evidence comprising broadcasting over a communications medium and offering an incentive to a party who submits evidence regarding invalidation of an intellectual property and organizing a database of intellectual property invalidation evidence.

In certain embodiments of the invention, the evidence can be solicited without the knowledge of the intellectual property holder, who can then be contacted regarding the existence of such information.

In certain embodiments directed to invalidation evidence of a patent, the communications medium is not a website.

For purposes of the present invention, the term “infringement evidence” means information regarding infringement of patent, a trademark or a copyright. The evidence may regard actual or perceived infringement.

The term “broadcasting” means disseminating evidence to at least one person over a communications medium.

The term “a description of intellectual property” means that the patent, trademark or copyright is described, without actually broadcasting the actual intellectual property. For example, the composition of matter or process encompassed by a patent claims can be described by audio and/or visual aid (e.g., text or image) without broadcasting the patent claim.

The term“communications medium” means any medium for disseminating information, including but not limited to direct mail, internet, television, radio, satellite, or direct personal contact. In certain embodiments, the communication medium is continuously directed to the present invention and is not a one-time occurrence such as a posting on a message board.

The term“incentive” means any consideration in exchange for the desired evidence, including but not limited to monetary payment, merchandise, service, stocks, bonds, stock options, and the like. The consideration can also be a coupon or voucher regarding any of the above.

The term“hosting” means the party bringing the intellectual property owner in contact with the person with the infringement evidence (or invalidation evidence). For example, the host can be a website with an ongoing service for making the connection between the two.

The term “user” means the individual, group of individuals or corporation having an interest in the intellectual property. For example, the user can be the direct owner, assignee, licensee, or any party with an interest in the intellectual property.

The term “verification” means that the evidence is checked to determine its usefulness or simply to screen out unsubstantiated, false or mistaken evidence.

The term“action being taken” means taking any legal remedy against the alleged infringer, including but not limited to a cease and desist letter, an infringement action, an offer of negotiation, and the like.

The term “positive outcome” means collection of damages, the cease of the infringement activity, the consummation of an assignment or license agreement or any other successful outcome of an action taken.

The term “invalidation evidence” means any information which can invalidate a patent, trademark and/or copyright by any legal means. Examples of invalidation evidence includes prior art, evidence of genericism, evidence of prior use, evidence of plagiarism, inequitable conduct, etc. Other means will be known to one skilled in the art.

Chisum on Patents, McCarthy on Trademarks and Nimmer on Copyrights are hereby incorporated by reference in their entirety for all purposes, including evidence infringement and invalidation of intellectual property.

### DETAILED DESCRIPTION

The present invention is directed to a method of obtaining infringement evidence on patents, trademarks and/or copyrights comprising broadcasting a description of the patent, trademark or copyright over a communications medium and offering an incentive to a party who submits evidence regarding infringement of the intellectual property. In certain embodiments, the broadcast comprises a description of the intellectual property on a website or a description of the desired evidence.

In the case of a patent, the description can include a claim or claims of the patent, a drawing or a specification of the invention. The whole patent or part of the patent can be on display, and/or a synapsis or summary of the patent. Alternatively, the broadcast can be of the desired evidence without a description of the patent.

By way of example, a company can have rights in a patent as to the method of manufacture of a product. As many competing companies do not publicize many of their procedures, the present invention will allow the intellectual property holder to assemble a team of detectives who may possibly already know or be in a position to discover such evidence. The team can include former or current employees of an infringing company, or can include independent contractors of the infringing company who may have knowledge of the infringing act.

In the case of a trademark, the description can include a written description and/or a picture of the actual trademark or the likeness of the trademark.

By way of example, the trademark holder of a cartoon character can post a drawing of the cartoon character on a website and solicit a team of detectives to submit evidence of infringement which may be already known or subsequently discovered. The present invention could supply the trademark holder with multiple individuals who can scan, e.g., billboards, store fronts or newspaper advertisements and submit information as to the unlicenced use of the cartoon character. Thus, the present invention can reduce payroll (as a company would not have to pay employee salaries for such people) and prevent or reduce the dilution of a trademark.

In the case of a copyright, the description can include a written description and /or a picture or auditory signal of the actual copyright or the likeness of the copyright.

By way of example, the copyright holder of a song can broadcast the song over a website and solicit a team of detectives to submit evidence of infringement of the song which may be already known or subsequently discovered. The present invention could supply the copyright holder with multiple individuals who can listen to, e.g., bands, or television or radio advertisements and submit information as to the unlicenced use of the song.

In certain embodiments, the method of the present invention can comprise providing a communications medium; broadcasting over the communications medium a description of intellectual property or a description of desired intellectual property infringement evidence and offering an incentive offer to a party who submits evidence regarding infringement of the intellectual property.

For example, intellectual property holder can have their own website used exclusively or non-exclusively for the present invention, and broadcast the description of intellectual property over their own website and offer an incentive to people to forward them information.

In certain embodiments, the method of the present invention can comprise hosting a communications medium; soliciting a user to broadcast over said communications medium a description of intellectual property or a description of desired intellectual property infringement evidence and an incentive offer to a party who submits evidence regarding infringement of said intellectual property. In other embodiments, the host will do the broadcast on behalf of the intellectual property holder. The offer will request the evidence be forwarded directly to the intellectual property holder or indirectly through the host.

For example, the person or corporation with their own website can solicit a patent holder to post their patent claims on the host's website and offer an incentive to people to forward them infringement evidence.

In certain embodiments, the method of the invention comprises contacting a host of a communications medium; broadcasting over said communications medium a description of intellectual property or a description of desired intellectual property infringement evidence and an incentive offer to a party who submits evidence regarding infringement of said intellectual property.

In such an embodiment, a trademark holder can post a banner ad on a popular website and offer an inventive for infringement evidence of the trademark. In another embodiment, a radio station can transmit a sound byte of a song and offer an inventive in accordance with the invention.

In certain embodiments, the method of obtaining infringement evidence comprises broadcasting over a communications medium and offering an incentive to a party who submits evidence regarding infringement of an intellectual property. In such an embodiment, the infringement evidence can be obtained without the knowledge of the intellectual property holder, who can then be subsequently contacted regarding the existence of such information.

In certain embodiments, the method of obtaining infringement evidence comprising broadcasting over a communications medium and offering an incentive to a party who submits evidence regarding infringement of an intellectual property and organizing a database of intellectual property infringement evidence. The general public can then view, e.g., a website listing the actual information or the existence of such information and then request or negotiate the source of the information.

The above detailed description of infringement information can also be applied to invalidation information.

The intellectual property of the present invention can be a patent, a trademark or a copyright.

The communications medium of the present invention can be, e.g., a television network, a radio network, an internet medium, a telephone network, a cellular network, a postal network, or any method of disseminating information.

When the communications medium is a television network, the broadcasting can be, e.g., by television signal, by cable transmission or by satellite transmission.

When the communications medium is an internet medium, the broadcasting can be, e.g., a website or an e-mail address.

The incentive of the present invention can be, e.g., a monetary payment, a discount coupon, merchandise, a merchandise voucher, a service, a service voucher, or any subjective or objective value, whether it be material or non-material.

The incentive can be, e.g., conditional upon verification, conditional upon action being taken, conditional upon action being taken which results in a positive outcome (e.g., a percentage of recovered damages), or can be without any condition.

In certain embodiments, the person supplying the information, the receiver of the information and the intellectual property holder can be anonymous independently of each other.

The disclosed embodiments of the invention can also be used to provide an interested party with a method of obtaining evidence of wrongdoing of another party, such as the violation of any civil or criminal laws, without limitation to intellectual property.

I claim:

1. A method of obtaining infringement evidence comprising broadcasting a description of intellectual property over a communications medium and offering an incentive to a party who submits evidence regarding infringement of said intellectual property.

2. A method of obtaining infringement evidence comprising broadcasting a description of desired intellectual property infringement evidence over a communications medium and offering an incentive to a party who submits said evidence.

3. A method of obtaining infringement evidence comprising
providing a communications medium;
broadcasting over said communications medium a description of intellectual property and
an incentive offer to a party who submits evidence regarding infringement of said intellectual property.

4. A method of obtaining infringement evidence comprising
providing a communications medium;
broadcasting over said communications medium a description of desired intellectual property infringement evidence and an incentive offer to a party who submits said evidence.

5. A method of obtaining infringement evidence comprising
hosting a communications medium;
soliciting a user to broadcast over said communications medium a description of intellectual property and an incentive offer to a party who submits evidence regarding infringement of said intellectual property.

6. A method of obtaining infringement evidence comprising
hosting a communications medium;
soliciting a user to broadcast over said communications medium a description of desired intellectual property infringement evidence and an incentive offer to a party who submits evidence regarding infringement of said intellectual property.

7. A method of obtaining infringement evidence comprising
hosting a communications medium;
soliciting to broadcast on behalf of a user over said communications medium a description of intellectual property and an incentive offer to a party who submits evidence regarding infringement of said intellectual property.

8. A method of obtaining infringement evidence comprising
hosting a communications medium;
soliciting to broadcast on behalf of a user over said communications medium a description of intellectual property infringement evidence and an incentive offer to a party who submits evidence regarding infringement of said intellectual property.

9. A method of obtaining infringement evidence comprising
hosting a communications medium;
soliciting users to broadcast a description of intellectual property over said communications medium and offer an incentive to a party who submits evidence regarding infringement of said intellectual property and
allowing said user to broadcast over said communications medium a description of intellectual property and an incentive offer to a party who submits evidence regarding infringement of said intellectual property.

10. A method of obtaining infringement evidence comprising
hosting a communications medium; soliciting users to broadcast a description of desired intellectual property infringement evidence over said communications medium and offer an incentive to a party who submits evidence regarding infringement of said intellectual property and
allowing said user to broadcast over said communications medium a description of desired intellectual property infringement evidence and an incentive offer to a party who submits evidence regarding infringement of said intellectual property.

11. A method of obtaining infringement evidence comprising
hosting a communications medium;
soliciting users who desire intellectual property infringement evidence and
broadcasting on behalf of said user a description of intellectual property over said communications medium and offer an incentive to a party who submits evidence regarding infringement of said intellectual property.

12. A method of obtaining infringement evidence comprising
hosting a communications medium;
soliciting users who desire intellectual property infringement evidence and
broadcasting on behalf of said user over said communications medium a description of desired intellectual property infringement evidence and an incentive offer to a party who submits evidence regarding infringement of said intellectual property.

13. A method of obtaining infringement evidence comprising
contacting a host of a communications medium;
broadcasting over said communications medium a description of intellectual property and an incentive offer to a party who submits evidence regarding infringement of said intellectual property.

14. A method of obtaining infringement evidence comprising
contacting a host of a communications medium;
broadcasting over said communications medium a description of desired intellectual property infringement evidence and an incentive offer to a party who submits evidence regarding infringement of said intellectual property.

15. A method of obtaining infringement evidence comprising
contacting a host of a communications medium;
having said host broadcasting over said communications medium a description of intellectual property and an incentive offer to a party who submits evidence regarding infringement of said intellectual property.

16. A method of obtaining infringement evidence comprising
contacting a host of a communications medium;
having said host broadcasting over said communications medium a description of intellectual property infringement evidence and an incentive offer to a party who submits evidence regarding infringement of said intellectual property.

17. A method of obtaining infringement evidence comprising broadcasting over a communications medium and offering an incentive to a party who submits evidence regarding infringement of an intellectual property.

18. A method of obtaining infringement evidence comprising broadcasting over a communications medium and offering an incentive to a party who submits evidence regarding infringement of an intellectual property and
organizing a database of intellectual property infringement evidence.

19. The method of claims 1-18 wherein said intellectual property is a patent, a trademark or a copyright.

20. The method of claim 19 wherein said intellectual property is a patent.

21. The method of claim 19 wherein said intellectual property is a trademark.

22. The method of claims 19 wherein said intellectual property is a copyright.

23. The method of claims 1-18 and 20-22 wherein said communications medium is a television network, a radio network, an internet medium, a telephone network, a cellular network or a postal network.

24. The method of claim 23 wherein said communications medium is a television network and said broadcasting is by television signal, by cable transmission or by satellite transmission.

25. The method of claim 23 wherein said communications medium is a radio network and said broadcast is by radio transmission.

26. The method of claim 23 wherein said communications medium is an internet medium.

27. The method of claims 26 wherein said internet medium is a website and said broadcasting comprises providing said description and said offer on said website.

28. The method of claims 26 wherein said internet medium is a website and said broadcasting comprises e-mailing said description and said offer from said website.

29. The method of claims 26 wherein said internet medium is an e-mail address and said broadcasting comprises e-mailing said description and said offer from said e-mail address.

30. The method of claims 1-18, 20-22 and 24-29 wherein said incentive is a monetary payment.

31. The method of claims 1-18, 20-22 and 24-29 wherein said incentive is a discount coupon.

32. The method of claims 1-18, 20-22 and 24-29 wherein said incentive is merchandise.

33. The method of claims 1-18, 20-22 and 24-29 wherein said incentive is a merchandise voucher.

34. The method of claims 1-18, 20-22 and 24-29 wherein said incentive is a service.

35. The method of claims 1-18, 20-22 and 24-29 wherein said incentive is a service voucher.

36. The method of claims 1-18, 20-22 and 24-29 wherein said incentive is conditional upon verification.

37. The method of claims 1-18, 20-22 and 24-29 wherein said incentive is conditional upon action being taken.

38. The method of claims 1-18, 20-22 and 24-29 wherein said incentive is conditional upon action being taken which results in a positive outcome.

39. The method of claims 1-18, 20-22 and 24-29 wherein said incentive is non-conditional.

40. A method of obtaining trademark and/or copyright invalidation evidence comprising broadcasting a description of a trademark and/or copyright over a communications medium and offering an incentive to a party who submits evidence regarding invalidation of the trademark and/or copyright.

41. A method of obtaining trademark and/or copyright invalidation evidence comprising broadcasting a description of desired trademark and/or copyright invalidation evidence over a communications medium and offering an incentive to a party who submits evidence regarding invalidation of the trademark and/or copyright.

42. A method of obtaining trademark and/or copyright invalidation evidence comprising
providing a communications medium;
broadcasting over said communications medium a description of a trademark and/or copyright and an incentive offer to a party who submits evidence regarding invalidation of said trademark and/or copyright.

43. A method of obtaining trademark and/or copyright invalidation evidence comprising
providing a communications medium;
broadcasting over said communications medium a description of desired trademark and/or copyright invalidation evidence and an incentive offer to a party who submits evidence regarding invalidation of said trademark and/or copyright.

44. A method of obtaining trademark and/or copyright invalidation evidence comprising
hosting a communications medium;
soliciting a user to broadcast over said communications medium a description of a trademark and/or copyright and an incentive offer to a party who submits evidence regarding invalidation of said trademark and/or copyright.

45. A method of obtaining trademark and/or copyright invalidation evidence comprising
hosting a communications medium;
soliciting a user to broadcast over said communications medium a description of desired trademark and/or copyright invalidation evidence and an incentive offer to a party who submits evidence regarding invalidation of said trademark and/or copyright.

46. A method of obtaining trademark and/or copyright invalidation evidence comprising
hosting a communications medium;
soliciting to broadcast on behalf of a user over said communications medium a description of a trademark and/or copyright and an incentive offer to a party who submits evidence regarding invalidation of said trademark and/or copyright.

47. A method of obtaining trademark and/or copyright invalidation evidence comprising
hosting a communications medium;
soliciting to broadcast on behalf of a user over said communications medium a description of trademark and/or copyright invalidation evidence and an incentive offer to a party who submits evidence regarding invalidation of said trademark and/or copyright.

48. A method of obtaining trademark and/or copyright invalidation evidence comprising
hosting a communications medium;
soliciting users to broadcast a description of a trademark and/or copyright over said communications medium and offer an incentive to a party who submits evidence regarding invalidation of said trademark and/or copyright and
allowing said user to broadcast over said communications medium a description of a trademark and/or copyright and an incentive offer to a party who submits evidence regarding invalidation of said trademark and/or copyright.

49. A method of obtaining trademark and/or copyright invalidation evidence comprising
hosting a communications medium;
soliciting users to broadcast a description of desired trademark and/or copyright invalidation evidence over said communications medium and an offer an incentive to a party who submits evidence regarding invalidation of said trademark and/or copyright and
allowing said user to broadcast over said communications medium a description of desired trademark and/or copyright invalidation evidence and an incentive offer to a party who submits evidence regarding invalidation of said trademark and/or copyright.

50. A method of obtaining trademark and/or copyright invalidation evidence comprising
hosting a communications medium;
soliciting users who desire trademark and/or copyright invalidation evidence and
broadcasting on behalf of said user a description of a trademark and/or copyright over said communications medium and offer an incentive to a party who submits evidence regarding invalidation of said trademark and/or copyright.

51. A method of obtaining trademark and/or copyright invalidation evidence comprising
hosting a communications medium;
soliciting a user who desires trademark and/or copyright invalidation evidence and
broadcasting on behalf of said user over said communications medium a description of desired trademark and/or copyright invalidation evidence and an incentive offer to a party who submits evidence regarding invalidation of said intellectual property.

52. A method of obtaining trademark and/or copyright invalidation evidence comprising
contacting a host of a communications medium;
broadcasting over said communications medium a description of a trademark and/or copyright and an incentive offer to a party who submits evidence regarding invalidation of said trademark and/or copyright.

53. A method of obtaining trademark and/or copyright invalidation evidence comprising
contacting a host of a communications medium;
broadcasting over said communications medium a description of desired trademark and/or copyright invalidation evidence and an incentive offer to a party who submits evidence regarding invalidation of said trademark and/or copyright.

54. A method of obtaining trademark and/or copyright invalidation evidence comprising
contacting a host of a communications medium;
having said host broadcasting over said communications medium a description of a trademark and/or copyright and an incentive offer to a party who submits evidence regarding invalidation of said intellectual property.

55. A method of obtaining trademark and/or copyright invalidation evidence comprising
contacting a host of a communications medium;
having said host broadcast over said communications medium a description of trademark and/or copyright invalidation evidence and an incentive offer to a party who submits evidence regarding invalidation of said trademark and/or copyright.

56. A method of obtaining trademark and/or copyright invalidation evidence comprising
broadcasting over a communications medium and offering an incentive to a party who submits evidence regarding invalidation of a trademark and/or copyright.

57. A method of obtaining trademark and/or copyright invalidation evidence comprising
broadcasting over a communications medium and offering an incentive to a party who submits evidence regarding invalidation of a trademark and/or copyright and
organizing a database of trademark and/or copyright invalidation evidence.

58. A method of obtaining patent invalidation evidence comprising
broadcasting a description of a patent over a communications medium except for a website and offering an incentive to a party who submits evidence regarding invalidation of the patent.

59. A method of obtaining patent invalidation evidence comprising broadcasting a description of desired patent invalidation evidence over a communications medium except for a website and offering an incentive to a party who submits evidence regarding invalidation of the patent.

60. A method of obtaining patent invalidation evidence comprising
providing a communications medium;
broadcasting over said communications medium a description of a patent and an incentive offer to a party who submits evidence regarding invalidation of said patent.

61. A method of obtaining patent invalidation evidence comprising
providing a communications medium;
broadcasting over said communications medium a description of desired patent invalidation evidence and an incentive offer to a party who submits evidence regarding invalidation of said patent.

62. A method of obtaining patent invalidation evidence comprising
hosting a communications medium except for a website;
soliciting a user to broadcast over said communications medium a description of a patent and an incentive offer to a party who submits evidence regarding invalidation of said patent.

63. A method of obtaining patent invalidation evidence comprising
hosting a communications medium except for a website;
soliciting a user to broadcast over said communications medium a description of desired patent invalidation evidence and an incentive offer to a party who submits evidence regarding invalidation of said patent.

64. A method of obtaining patent invalidation evidence comprising
hosting a communications medium except for a website;
soliciting to broadcast on behalf of a user over said communications medium a description of a patent and an incentive offer to a party who submits evidence regarding invalidation of said patent.

65. A method of obtaining patent invalidation evidence comprising
hosting a communications medium except for a website;
soliciting to broadcast on behalf of a user over said communications medium a description of patent invalidation evidence and an incentive offer to a party who submits evidence regarding invalidation of said patent.

66. A method of obtaining patent invalidation evidence comprising
hosting a communications medium except for a website;
soliciting users to broadcast a description of a patent over said communications medium and offer an incentive to a party who submits evidence regarding invalidation of said patent and allowing said user to broadcast over said communications medium a description of a patent and an incentive offer to a party who submits evidence regarding invalidation of said patent.

67. A method of obtaining patent invalidation evidence comprising
hosting a communications medium except for a website;
soliciting users to broadcast a description of desired patent invalidation evidence over said communications medium and an offer an incentive to a party who submits evidence regarding invalidation of said patent and
allowing said user to broadcast over said communications medium a description of desired patent invalidation evidence and an incentive offer to a party who submits evidence regarding invalidation of said patent.

68. A method of obtaining patent invalidation evidence comprising
hosting a communications medium except for a website;
soliciting users who desire patent invalidation evidence and
broadcasting on behalf of said user a description of a patent over said communications medium and offer an incentive to a party who submits evidence regarding invalidation of said patent.

69. A method of obtaining patent invalidation evidence comprising
hosting a communications medium except for a website;
soliciting a user who desires patent invalidation evidence and
broadcasting on behalf of said user over said communications medium a description of desired patent invalidation evidence and an incentive offer to a party who submits evidence regarding invalidation of said intellectual property.

70. A method of obtaining patent invalidation evidence comprising
contacting a host of a communications medium except for a website;
broadcasting over said communications medium a description of a patent and an incentive offer to a party who submits evidence regarding invalidation of said patent.

71. A method of obtaining patent invalidation evidence comprising
contacting a host of a communications medium except for a website;
broadcasting over said communications medium a description of desired patent invalidation evidence and an incentive offer to a party who submits evidence regarding invalidation of said patent.

72. A method of obtaining patent invalidation evidence comprising
contacting a host of a communications medium except for a website;
having said host broadcasting over said communications medium a description of a patent and an incentive offer to a party who submits evidence regarding invalidation of said intellectual property.

73. A method of obtaining patent invalidation evidence comprising
contacting a host of a communications medium except for a website;
having said host broadcast over said communications medium a description of patent invalidation evidence and an incentive offer to a party who submits evidence regarding invalidation of said patent.

74. A method of obtaining patent invalidation evidence comprising broadcasting over a communications medium and offering an incentive to a party who submits evidence regarding invalidation of a patent.

75. A method of obtaining patent invalidation evidence comprising broadcasting over a communications medium and offering an incentive to a party who submits evidence regarding invalidation of a patent and organizing a database of patent invalidation evidence.
